(19) United States
(12) Patent Application Publication
(10) Pub. No.: US 2007/0060727 A1
(43) Pub. Date: Mar. 15, 2007

(54) Multistep process for preparing heterophasic propylene copolymers

(75) Inventors: Anteo Pelliconi, Occhiobello-Rovigo (IT); Maria Silvia Tonti, Ferrara (IT); Luigi Resconi, Ferrara (IT)

Correspondence Address: BASELL USA INC., INTELLECTUAL PROPERTY, 912 APPLETON ROAD, ELKTON, MD, 21921, US

(73) Assignee: Basel Polyolefine Gmbh, Wesswling (DE)

(21) Appl. No.: 10/571,389

(22) PCT Filed: Aug. 6, 2004
(86) PCT No.: PCT/EP04/08902

§ 371 Date: Mar. 10, 2006

Related U.S. Application Data
(60) Provisional application No. 60/508,429, filed on Sep. 22, 2003.

(30) Foreign Application Priority Data
Sep. 11, 2003 (EP) 03077867.4

(51) Int. Cl. C08F 4/44

(52) U.S. Cl. 526/127; 526/160; 526/943; 526/901; 526/905; 526/348.6

(57) ABSTRACT

A multistage process comprising the step of polymerizing propylene in the presence the presence of a catalysts system, comprising one or more metallocene compound of formula (I): wherein M is an atom of a transition metal; p is an integer from 0 to 3, X, same or different, is a hydrogen atom, a halogen atom, or a hydrocarbon group; L is a divalent bridging R¹ and R², are C₁-C₂₀-alkyl radicals; T, equal to or different from each other, is a moiety of formula (IIb) or (IIa): wherein R³, R⁴, R⁵, R⁶, R⁷, R^{3′}, R^{4′}, R^{5′}, R^{6′} and R^{7′}, are hydrogen atoms or hydrocarbon groups; with the proviso that at least one among R³, R⁴, R⁵, R⁶, R⁷ is different from hydrogen; R¹¹ is a hydrogen atom or a hydrocarbon group; R⁸, R⁹ and R¹⁰, are hydrogen atoms or hydrocarbon groups; and further comprising the step of contacting, under polymerization conditions, in a gas phase, ethylene and one or more comonomers. Where the amount of the polymer obtained in the first step ranges from 5% by weight and 90% by weight, of the polymer obtained in the whole process.

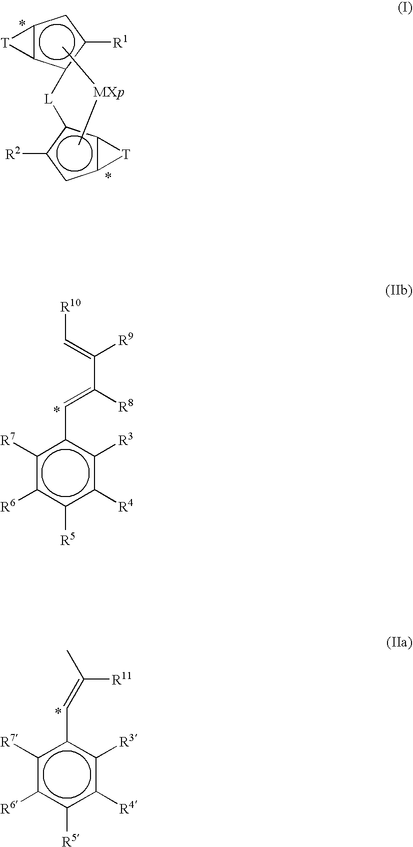

The present invention relates to a multistep process for preparing heterophasic propylene copolymers, by using a metallocene-based catalyst.

Multistep processes for the polymerization of olefins, carried out in two or more reactors, are known from the patent literature and are of particular interest in industrial practice. The possibility of independently varying, in any reactors, process parameters such as temperature, pressure, type and concentration of monomers, concentration of hydrogen or other molecular weight regulator, provides much greater flexibility in controlling the composition and properties of the end product compared to single-step processes. Multistep processes are generally carried out using the same catalyst in the various steps/reactors. The product obtained in one reactor is discharged and sent directly to the next step/reactor without altering the nature of the catalyst.

Usually a crystalline polymer is prepared in the first stage followed by a second stage in which an elastomeric copolymer is obtained. The monomer used in the first stage is usually also used as comonomer in the second stage. This simplifies the process, for the reason that it is not necessary to remove the unreacted monomer from the first stage, but this kind of process has the drawback that only a limited range of products can be prepared.

U.S. Pat. No. 5,854,354 discloses a multistep process in which a propylene polymer is prepared in step a) followed by an ethylene (co)polymer prepared in step b). This document describes that the amount of the ethylene polymer ranges from 20% to 80% by weight of the total polymer, but in the examples only compositions containing about 30% of ethylene polymer are prepared. In this document it is shown that when the comonomer used in step b) is 1-butene or higher alpha-olefins rigidity, heat resistance and impact resistance can be improved.

There is still the need to improve other properties such as the haze in order to use these heterophasic ethylene copolymers in applications that requires high values of transparency (low values of haze).

The applicant found that an heterophasic copolymer comprising a propylene homo or copolymer and an ethylene/1-butene or higher alpha olefins copolymer having a lower value of haze is obtainable in a two step process when a certain class of metallocene compounds defined by a particular substitution pattern is used as catalyst components.

The multistage process according to the present invention comprises the following steps:
step a) polymerizing propylene and optionally one or more monomers selected from ethylene or alpha olefins of formula CH₂═CHT¹, wherein T¹ is a C₂-C₂₀ alkyl radical in the presence of a catalyst system supported on an inert carrier, comprising:
i) one or more metallocene compound of formula (I): 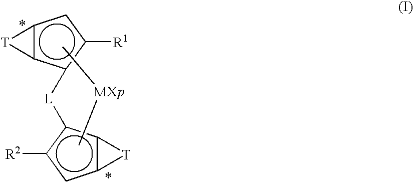
   wherein:
   M is an atom of a transition metal selected from those belonging to group 3, 4, 5, 6 or to the lanthanide or actinide groups in the Periodic Table of the Elements; preferably M is titanium, zirconium or hafnium;
   p is an integer from 0 to 3, preferably p is 2, being equal to the formal oxidation state of the metal M minus 2;
   X, same or different, is a hydrogen atom, a halogen atom, or a R, OR, OSO₂CF₃, OCOR, SR, NR₂ or PR₂ group, wherein R is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical, optionally containing heteroatoms belonging to groups 13-17 of the Periodic Table of the Elements; or two X can optionally form a substituted or unsubstituted butadienyl radical or a OR′O group wherein R′ is a divalent radical selected from C₁-C₂₀ alkylidene, C₆-C₄₀ arylidene, C₇-C₄₀ alkylarylidene and C₇-C₄₀ arylalkylidene radicals; preferably X is a hydrogen atom, a halogen atom or a R group;
   more preferably X is chlorine or a methyl radical;
   L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms such as SiMe₂, SiPh₂;
   preferably L is selected from the group consisting of Si(CH₃)₂, SiPh₂, SiPhMe, SiMe(SiMe₃), CH₂, (CH₂)₂, (CH₂)₃ and C(CH₃)₂;
   R¹ and R², equal to or different from each other, are linear or branched, saturated or unsaturated C₁-C₂₀-alkyl radicals, optionally containing one or more heteroatoms belonging to groups 13-17 of the Periodic Table of the Elements; preferably R¹ and R² are methyl or ethyl radicals;
   T, equal to or different from each other, is a moiety of formula (IIa) or (IIb): 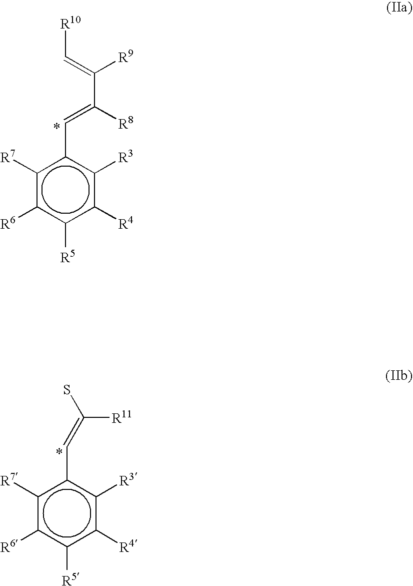
   wherein:
   the atom marked with the symbol * bonds the atom marked with the same symbol in the compound of formula (I);
   R³, R⁴, R⁵, R⁶ and R⁷, equal to or different from each other, are hydrogen atoms or linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; or
   two or more R³, R⁴, R⁵, R⁶ and R⁷ can join to form a 4-7 saturated or unsaturated membered rings, said ring can bear C₁-C₂₀ all substituents; with the proviso that at least one among R³, R⁴, R⁵, R⁶ and R⁷ is a group of formula (III): 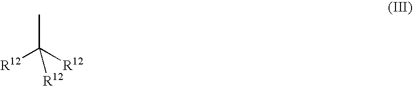
   wherein R¹², equal to or different from each other, is a C₁-C₁₀ alkyl radical, preferably R¹² is a methyl or ethyl radical;
   R⁸, R⁹ and R¹⁰, equal to or different from each other, are hydrogen atoms or linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; or two or more R⁸, R⁹ and R¹⁰ can join to form a 4-7 saturated or unsaturated membered rings, said ring can bear one or more C₁-C₁₀ alkyl substituents;
   R¹¹ is a hydrogen atom or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; preferably R¹¹ is a linear or branched, saturated C₁-C₂₀-alkyl, such as a methyl, ethyl or isopropyl radical;
   R^{3′}, R^{4′}, R^{5′}, R^{6′} and R^{7′} equal to or different from each other, are hydrogen atoms or linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; or
   two or more R^{3′} R^{4′} R^{5′} R^{6′} and R^{7′} can join to form a 4-7 saturated or unsaturated membered rings, said ring can bear C₁-C₂₀ alkyl substituents; preferably at least one among R^{3′}, R^{4′}, R^{5′}, R^{6′} and R^{7′} is a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radical, optionally containing one or more heteroatoms belonging to groups 13-17 of the Periodic Table of the Elements; more preferably at least one among R^{3′}, R^{4′}, R^{5′}, R^{6′} and R^{7′} is a group of formula (III) described above;
ii) an alumoxane or a compound capable of forming an alkyl metallocene cation; and optionally
iii) an organo aluminum compound;
step b) contacting, under polymerization conditions, in a gas phase, ethylene with one or more alpha olefins of formula CH₂═CHT¹, wherein T¹ is a C₂-C₂₀ alkyl radical, and optionally a non-conjugated diene, in the presence of the polymer obtained in step a) and optionally in the presence of an additional organo aluminum compound;
   wherein the amount of the polymer obtained in step a) ranges from 5% by weight to 90% by weight of the polymer obtained in the whole process and the amount of polymer obtained in step b) ranges from 10% by weight to 95% by weight of the polymer obtained in the whole process.

The compound of formula (I) is preferably in the form of the racemic or racemic-like isomers. “Racemic-like” means that the benzo or thiophene moieties of the two n-ligands on the metallocene compound of formula (I) are on the opposite sides with respect to the plane containing the zirconium and the centre of the cyclopentadienyl moieties as shown in the following compound.

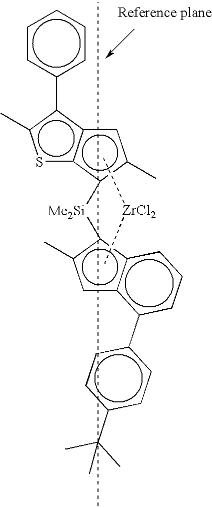

Preferably in the moiety of formula (IIb) R^{5′} is a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radical, optionally containing one or more heteroatoms belonging to groups 13-17 of the Periodic Table of the Elements; more preferably R^{5′} is a group of formula (III) described above.

Preferably in the moiety of formula (IIa) R³, R⁴, R⁶ and R⁷, are hydrogen atoms.

Preferably in the moiety of formula (IIb) R^{3′}, R^{4′}, R^{6′} and R^{7′} are hydrogen atoms.

In one embodiment, in the compound of formula (I), T are the same and they have formula (IIa) wherein R⁹ is a C₁-C₂₀ alkyl radical; preferably it is a C₁-C₁₀ alkyl radical; more preferably R⁹ is a methyl or ethyl group.

In a further embodiment, in the compound of formula (I) T are the same and they have formula (IIb).

In a further embodiment, in the compound of formula (I) T are the same and they have formula (IIa) wherein R⁹ is hydrogen atom.

In a further embodiment, in the compound of formula (I) T are different and they have formulas (IIb) and (IIa).

In a still further embodiment, in the compound of formula (I) T are the same and they have formula (IIb) wherein R¹¹ is a linear or branched, saturated C₁-C₂₀-alkyl radical, such as a methyl, ethyl or isopropyl radical.

Compounds of formula (I) are known in the art, for example they can be prepared according to according to WO 98/40331, WO 01/48034, WO 03/045964 and DE 10324541.3.

The catalyst system used in the process of the present invention is supported on an inert carrier. This is achieved by depositing the metallocene compound i) or the product of the reaction thereof with the component ii), or the component ii) and then the metallocene compound i) on an inert support. Examples of inert supports are inorganic oxides such as, for example, silica, alumina, Al—Si, Al—Mg mixed oxides, magnesium halides, organic polymeric supports such as styrene/divinylbenzene copolymers, polyethylene or polypropylene. The supportation process is carried out in an inert solvent, such as hydrocarbon selected from toluene, hexane, pentane and propane and at a temperature ranging from 0° C. to 100° C., more preferably from 30° C. to 60° C.

In one embodiment the preferred support are inorganic oxides, preferably silica.

In another embodiment the preferred supports are porous organic polymers such as styrene/divinylbenzene copolymers, polyamides, or polyolefins.

Preferably porous alpha-olefin polymers are polyethylene, polypropylene, polybutene, copolymers of propylene and copolymers of ethylene.

Two particularly suitable classes of porous propylene polymers are those obtained according to WO 01/46272 and WO 02/051887 particularly good results are obtained when the catalyst described WO 01/46272 is used with the process described in WO 02/051887. Polymers obtained according to WO 01/46272 have a high content of the so-called stereoblocks, i.e. of polymer fractions which, although predominantly isotactic, contain a not negligible amount of non-isotactic sequences of propylene units. In the conventional fractionation techniques such as the TREF (Temperature Rising Elution Temperature) those fractions are eluted at temperatures lower than those necessary for the more isotactic fractions. The polymers obtained according to the process described in WO 02/051887 show improved porosity.

The porous organic polymer has preferably porosity due to pores with diameter up 10 μm (100000 Å) measured to the method reported below, higher than 0.1 cc/g preferably comprised between 0.2 cc/g to 2 cc/g; more preferably from 0.3 cc/g to 1 cc/g.

In the porous organic polymer fit as support according to the process of the present invention, the total porosity due to all pores whose diameter is comprised between 0.1 μm (1000 Å) and 2 μm (20000 Å) is at least 30% of the total porosity due to all pores whose diameter is comprised between 0.02 μm (200 Å) and 10 μm (100000 Å). Preferably the total porosity due to all pores whose diameter is comprised between 0.1 μm (1000 Å) and 2 μm (20000 Å) is at least 40% of the total porosity due to all pores whose diameter is comprised between 0.02 μm (200 Å) and 10 μm (100000 Å). More preferably the total porosity due all pores whose diameter is comprised between 0.1 μm (1000 Å) and 2 μm (20000 Å) is at least 50% of the total porosity due all pores whose diameter is comprised between 0.02 μm (200 Å) and 10 μm (100000 Å).

A particularly suitable process for supporting the catalyst system is described in WO 01/44319, wherein the process comprises the steps of:
(a) preparing a catalyst solution comprising a catalyst system;
(b) introducing into a contacting vessel:
   (i) a porous support material in particle form, and
   (ii) a volume of the catalyst solution not greater than the total pore volume of the porous support material introduced;
(c) discharging the material resulting from step (b) from the contacting vessel and suspending it in an inert gas flow, under such conditions that the solvent evaporates; and
   reintroducing at least part of the material resulting from step (c) into the contacting vessel together with another volume of the catalyst solution not greater than the total pore volume of the reintroduced material.

Alumoxanes used as component ii) can be obtained by reacting water with an organo-aluminium compound of formula HⱼAlU₃₋ⱼ, or HjAl₂U₆₋ⱼ, where U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or or C₇-C₂₀-arylalkyl radical, optionally containing silicon or germanium atoms with the proviso that at least one U is different from halogen, and j ranges from 0 to 1, being also a non-integer number. In this reaction the molar ratio of Al/water is preferably comprised between 1:1 and 100:1. The molar ratio between aluminium and the metal of the metallocene generally is comprised between about 10:1 and about 20000:1, and more preferably between about 100:1 and about 5000:1.

The alumoxanes used in the catalyst according to the invention are considered to be linear, branched or cyclic compounds containing at least one group of the type: 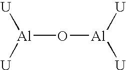
wherein the substituents U, same or different, are defined above.

In particular, alumoxanes of the formula: 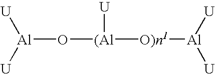
can be used in the case of linear compounds, wherein n¹ is 0 or an integer of from 1 to 40 and the substituents U are defined as above; or alumoxanes of the formula: 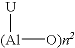
can be used in the case of cyclic compounds, wherein n² is an integer from 2 to 40 and the U substituents are defined as above.

Examples of alumoxanes suitable for use according to the present invention are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO).

Particularly interesting cocatalysts are those described in WO 99/21899 and in WO01/21674 in which the alkyl and aryl groups have specific branched patterns.

Non-limiting examples of aluminum compounds that can be reacted with water to give suitable alumoxanes (b), described in WO 99/21899 and WO01/21674, are: tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-dimethyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminum, tris(2-methyl-3-phenyl-butyl)aluminium, tris(2-ethyl-3-phenyl-butyl)aluminium, tris(2,3 dimethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3-methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Amongst the above aluminium compounds, trimethylaluminum (TMA), triisobutylaluminum (TIBA), tris(2,4,4-trimethyl-pentyl)aluminium (TIOA), tris(2,3-dimethylbutyl)aluminium (IDMBA) and tris(2,3,3-trimethylbutyl)aluminium CTITBA) are preferred.

Non-limiting examples of compounds able to form an alkylmetallocene cation are compounds of formula D⁺E⁻, wherein D⁺ is a Brønsted acid, able to donate a proton and to react irreversibly with a substituent X of the metallocene of formula (I) and E⁻ is a compatible anion, which is able to stabilize the active catalytic species originating from the reaction of the two compounds, and which is sufficiently labile to be removed by an olefinic monomer. Preferably, the anion E comprises one or more boron atoms. More preferably, the anion B is an anion of the formula BAr₄⁽⁻⁾, wherein the substituents Ar which can be identical or different are aryl radicals such as phenyl, pentafluorophenyl or bis(trifluoromethyl)phenyl. Tetrakis-pentafluorophenyl borate is particularly preferred compound, as described in WO 91/02012. Moreover, compounds of formula BAr₃ can be conveniently used. Compounds of this type are described, for example, in the International patent application WO 92/00333. Other examples of compounds able to form an alkylmetallocene cation are compounds of formula BAr₃P wherein P is a substituted or unsubstituted pyrrol radical. These compounds are described in WO01/62764. Compounds containing boron atoms can be conveniently supported according to the description of DE-A-19962814 and DE-A-19962910. All these compounds containing boron atoms can be used in a molar ratio between boron and the metal of the metallocene comprised between about 1:1 and about 10:1; preferably 1:1 and 2.1; more preferably about 1:1.

Non limiting examples of compounds of formula D⁺E⁻ are:
Triethylammoniumtetra(phenyl)borate,
Tributylammoniumtetra(phenyl)borate,
Trimethylammoniumtetra(tolyl)borate,
Tributylammoniumtetra(tolyl)borate,
Tributylammoniumtetra(pentafluorophenyl)borate,
Tributylammoniumtetra(pentafluorophenyl)aluminate,
Tripropylammoniumtetra(dimethylphenyl)borate,
Tributylammoniumtetra(trifluoromethylphenyl)borate,
Tributylammoniumtetra(4-fluorophenyl)borate,
N,N-Dimethylbenzylammonium-tetrakispentafluorophenylborate,
N,N-Diinethylhexylamonium-tetrakisp entafluorophenylb orate,
N,N-Dimethylaniliniumtetra(phenyl)borate,
N,N-Diethylaniliniumtetra(phenyl)borate,
N,N-Dimethylaniliniumtetrakis(pentafluorophenyl)borate,
N,N-Dimethylaniliniumtetrakis(pentafluorophenyl)aluniinate,
N,N-Dimethylbenzylammonium-tetrakispentafluorophenylborate,
N,N-Dimethylhexylamonium-tetrakispentafluorophenylborate,
Di(propyl)ammoniumtetrakis(pentafluorophenyl)borate,
Di(cyclohexyl)ammoniumtetrakis(pentafluorophenyl)borate,
Triphenylphosphoniumtetrakis(phenyl)borate,
Triethylphosphoniumtetrakis(phenyl)borate,
Diphenylphosphoniumtetrakis(phenyl)borate,
Tri(methylphenyl)phosphoniumtetrakis(phenyl)borate,
Tri(dimethylphenyl)phosphoniumtetrakis(phenyl)borate,
Triphenylcarbeniumtetrakis(pentafluorophenyl)borate,
Triphenylcarbeniumtetrakis(pentafluorophenyl)aluminate,
Triphenylcarbeniumtetrakis(phenyl)aluminate,
Ferroceniumtetrakis(pentafluorophenyl)borate,
Ferroceniumtetrakis(pentafluorophenyl)aluminate.
Triphenylcarbeniumtetrakis(pentafluorophenyl)borate, and
N,N-Dimethylanlliniumtetrakis(pentafluorophenyl)borate.

Organic aluminum compounds used as compound iii) are those of formula HⱼAlU₃₋ⱼ or HⱼAl₂U₆₋ⱼ as described above.

Preferably step a) further comprises a prepolymerization step a-1).

The prepolymerization step a-1) can be carried out by contacting the catalyst system with ethylene propylene or one or more alpha olefins of formula CH₂═CHT¹, wherein T¹ is a C₂-C₂₀ alkyl radical. Preferably said alpha olefins are propylene or ethylene, at a temperature ranging from −20° C. to 70° C., in order to obtain a prepolymerized catalyst system preferably containing from 5 to 500 g of polymer per gram of catalyst system.

Thus preferably step a) comprises

a-1) contacting the catalyst system described above with ethylene and/or propylene and/or one ore more alpha olefins of formula CH₂═CHT¹, wherein T¹ is a C₂-C₂₀ alkyl radical; preferably propylene or ethylene. in order to obtain a prepolymerized catalyst system preferably containing from 5 to 500 g of polymer per gram of catalyst system;

a-2) polymerizing propylene and optionally one or more monomers selected from ethylene and alpha olefins of formula CH₂═CHT¹, wherein T¹ is a C₂-C₂₀ alkyl radical in the presence of the prepolymerized catalyst system obtained in step a-1).

Step a) of the present invention can be carried out in liquid phase, in which the polymerization medium can be an inert hydrocarbon solvent or the polymerization medium can be liquid propylene optionally in the presence of an inert hydrocarbon solvent, and of ethylene or one or more comonomer of formula CH₂═CHT¹, or step a) can be carried out in a gas phase. Said hydrocarbon solvent can be either aromatic (such as toluene) or aliphatic (such as propane, hexane, heptane, isobutane, cyclohexane and 2,2,4-trimethylpentane).

Preferably the polymerization medium is liquid propylene. It can optionally contain minor amounts (up to 20% by weight, preferably up to 10% by weight, more preferably up to 5% by weight) of an inert hydrocarbon solvent or of one or more comonomer such as ethylene or alpha-olefins of formula CH₂═CHT¹.

Step a) can be carried out in the presence of hydrogen. The ratio hydrogen/propylene present during the polymerization reaction is preferably higher than 1 ppm; more preferably it ranges from 5 to 2000 ppm; even more preferably from 6 to 500 ppm with respect to the propylene present in the reactor. Hydrogen can be added either at the beginning of the polymerization reaction or it can also be added at a later stage after a prepolymerization step has been carried out.

The propylene polymer obtained in step a) is a propylene homopolymer or a propylene copolymer containing up to 20% by mol preferably from 0.1 to 10% by mol, more preferably from 1% to 5% by mol of derived units of ethylene or one or more alpha olefins of formula CH₂═CHT¹. Non-limiting examples of alpha olefins of formula CH₂═CHT¹ which can be used in the process of the invention are 1-butene, 1-pentene, 4-methyl-1-pentene, 1-hexene, 1-octene, 4,6-dimethyl-1-heptene, 1-decene, 1-dodecene, 1-tetradecene, 1-hexadecene, 1-octadecene and 1-eicosene. Preferred comonomers are ethylene or 1-butene.

The amount of polymer obtained in step a) ranges from 5% to 90% by weight of the total polymer produced in the whole process, preferably it ranges from 30% to 70% by weight of the total polymer produced in the whole process; more preferably from 30% to 50% by weight of the total polymer produced in the whole process.

Preferably in step a) propylene homopolymer is prepared.

Step b) is carried out in a gas phase, preferably in a fluidized bed reactor or in a continuos stirrer tank reactor. The polymerization temperature is generally comprised between −100° C. and +200° C., and, preferably, between 10° C. and +100° C. The polymerization pressure is generally comprised between 0.5 and 100 bar. The amount of polymer obtained in step b) ranges from 10% to 95% by weight of the polymer produced in the whole process, preferably it ranges from 30% to 70% by weight of the polymer produced in the whole process, more preferably it ranges from 50% to 70% by weight of the polymer produced in the whole process.

Step b) can be carried out in the presence of hydrogen. The ratio hydrogen/hethylene present during the polymerization reaction is preferably higher than 1 ppm with respect to the ethylene present in the reactor; more preferably it ranges from 5 to 2000 ppm; even more preferably from 6 to 500 ppm.

In step b) an ethylene copolymer having from 4% by mol to 90% by mol, preferably from 5.5% by mol to 60% by mol of derived units of comonomers of formula CH₂═CHT¹ and optionally up to 20% of derived units of non conjugated diene, is produced. Examples of comonomer of formula CH₂═CHT¹ that can be used in step b) of the present invention are: 1-butene, 1-pentene, 4-methyl-1-pentene, 1-hexene, 1-octene, 4,6-dimethyl-1-heptene, 1-decene, 1-dodecene, 1-tetradecene, 1-hexadecene, 1-octadecene and 1-eicosene.

Preferred comonomer is 1-butene.

The polymer obtained in step b) can optionally contains up to 20% by mol of a non conjugated diene. Non conjugated dienes can be a straight chain, branched chain or cyclic hydrocarbon diene having from 6 to 20 carbon atoms. Examples of suitable non-conjugated dienes are:
straight chain acyclic dienes, such as 1,4-hexadiene and 1,6-octadiene;
branched chain acyclic dienes, such as 5-methyl-1,4-hexadiene, 3,7-dimethyl-1,6-octadiene, 3,7-dimethyl-1,7-octadiene and mixed isomers of dihydro myricene and dihydroocinene;
single ring alicyclic dienes, such as 1,3-cyclopentadiene, 1,4-cyclohexadiene, 1,5-cyclooctadiene and 1,5-cyclododecadiene;
multi-ring alicyclic fused and bridged ring dienes, such as tetrahydroindene, methyl tetrahydroindene, dicyclopentadiene, bicyclo-(2,2,1)-hepta-2,5-diene; and
alkenyl, alkylidene, cycloalkenyl and cycloalkylidene norbornenes, such as 5-methylene-2-norbornene (MNB), 5-propenyl-2-norbornene, 5-isopropylidene-2-norbornene, 5-(4-cyclopentenyl)-2-norbornene, 5-cyclohexylidene-2-norbornene, 5-vinyl-2-norbornene and norbornadiene.

Preferred dienes are 1,4-hexadiene (HD), 5-ethylidene-2-norbornene (ENB), 5-vinylidene-2-norbornene (VNB), 5-methylene-2-norbornene (MNB) and dicyclopentadiene (DCPD). Particularly preferred dienes are 5-ethylidene-2-norbornene (ENB) and 1,4-hexadiene (HD).

When present the non-conjugated dienes are generally incorporated into the polymer in an amount from 0.1% to about 20% by mol; preferably from 1% to 15% by mol, and more preferably from 2% to 7% by mol. If desired, more than one diene may be incorporated simultaneously, for example HD and ENB, with total diene incorporation within the limits specified above.

The process of the present invention can be carried out in one reactor or in two or more reactor in series.

The following examples are given to illustrate and not to limit the invention.

### EXAMPLES

General Characterization

Determination of X.S.

2.5 g of polymer were dissolved in 250 ml of o-xylene under stirring at 135° C. for 30 minutes, then the solution was cooled to 25° C. and after 30 minutes the insoluble polymer was filtered. The resulting solution was evaporated in nitrogen flow and the residue was dried and weighed to determine the percentage of soluble polymer (X.S.) and then, by difference, the insolubles (X.I.).

NMR

The proton and carbon spectra of polymers were obtained using a Bruker DPX 400 spectrometer operating in the Fourier transform mode at 120° C. at 400.13 MHz and 100.61 MHz respectively. The samples were dissolved in C₂D₂Cl₄. As reference the residual peak of C₂DHCl₄ in the ¹H spectra (5.95 ppm) and the peak of the mmmm pentad in the ¹³C spectra (21.8 ppm) were used. Proton spectra were acquired with a 45° pulse and 5 seconds of delay between pulses; 256 transients were stored for each spectrum, The carbon spectra were acquired with a 90° pulse and 12 seconds (15 seconds for ethylene based polymers) of delay between pulses and CPD (waltz 16) to remove ¹H-¹³C couplings. About 3000 transients were stored for each spectrum.

The intrinsic viscosity (I.V.) was measured in tetrahydronaphtalene (THN) at 135° C.

Porosity (mercury) is determined by immersing a known quantity of the sample in a known quantity of mercury inside a dilatometer and gradually hydraulically increasing the pressure of the mercury. The pressure of introduction of the mercury in the pores is in function of the diameter of the same. The measurement was carried out using a porosimeter “Porosimeter 2000 Series” (Carlo Erba). The total porosity was calculated from the volume decrease of the mercury and the values of the pressure applied.

The porosity expressed as percentage of voids (% V/V₁) is determined by absorption of mercury under pressure. The volume of mercury absorbed corresponds to the volume of the pores. For this determination, a calibrated dilatometer (diameter 3 mm) CD3 (Carlo Erba) connected to a reservoir of mercury and to a high-vacuum pump (1×10⁻² mbar) is used. A weighed amount of sample (about 0.5 g) is placed in the dilatometer. The apparatus is then placed under high vacuum (<0.1 mm Hg) and is maintained in these conditions for 10 minutes. The dilatometer is then connected to the mercury reservoir and the mercury is allowed to flow slowly into it until it reaches the level marked on the dilatometer at a height of 10 cm. The valve that connects the dilatometer to the vacuum pump is closed and the apparatus is pressurized with nitrogen (2.5 Kg/cm²). Under the effect of the pressure, the mercury penetrates into the pores and the level goes down according to the porosity of the material. Once the level at which the mercury has stabilized has been measured on the dilatometer, the volume of the pores is calculated from the equation V=R2πΔH, where R is the radius of the dilatometer and ΔH is the difference in cm between the initial and the final levels of the mercury in the dilatometer. By weighting the dilatometer, dilatometer+mercury, dilatometer+mercury+sample, the value of the apparent volume V₁ of the sample prior to penetration of the pores can be calculated. The volume of the sample is given by:
V₁=[P₁−(P₂−P)]/D

P is the weight of the sample in grams, P₁ is the weight of the dilameter+mercury in grams, P₂ is the weight of the dilatometer+mercury+sample in grams, D is the density of mercury (at 25° C. 13,546 g/cc). The percentage porosity is given by the relation:
X=(100V)/V₁.

The pore distribution curve, and the average pore size are directly calculated from the integral pore distribution curve which is function of the volume reduction of the mercury and applied pressure values (all these data are provided and elaborated by the porosimeter associated computer which is equipped with a “MILESTONE 200/2.04” program by C. Erba.

Bulk density (PBD) was measured according to DIN-53194.

Haze was measured according to ASTM D10003-61

Metallocene Compounds

rac-dimethylsilylbis(2-methyl-4-para-tert-butylphenyl)-indenyl)-zirconium dichloride (rac-Me₂Si(2-Me-4(4tBuPh)Ind)₂ZrCl₂) (A-1) was prepared according to WO 98/40331 (example 65).

rac-dimethylsilylbis(2-methyl-4-phenyl-indenyl)-zirconium dichloride (rac-Me₂Si(2-Me-4-Ph-Ind)₂ZrCl₂) (C-1) was prepared according to U.S. Pat. No. 5,786,432.

Organic Porous Support

Polyethylene prepolymer (support A) was produced according to the procedure described in example 1 of WO 95/26369, under the following conditions: polymerisation temperature 0° C., AliBu₃ (AliBu₃/ZN catalyst=1 (w/w)), 1.5 bar-g of ethylene (conversion of 40 g_{PE}/g_{cat}). The support has a PBD of 0.285 g/ml, porosity 0.507 cc/g, and % of pores having diameter comprised between 0.1 μm (1000 Å) and 2 μm (20000 Å) of 76.19%.

Preparation of the Catalyst System

Catalyst A

4.6 g of support A described above, were treated with H₂O dispersed in hexane in order to deactivate the MgCl₂/Ti-based catalyst, then dried in a flow of nitrogen. The support is contacted with 0.5 mL of MAO solution (30% w in toluene) diluted with 1.5 ml of toluene to scavenge impurities and residual water.

The catalytic complex was prepared by adding 42 mg of metallocene (A-1) in 4.1 ml of MAO solution (30% w/w in toluene).

The so obtained catalytic mixture is impregnated on support A (treated as described above) according to procedure described in WO 01/44319.

The obtained supported catalytic system contains 8.0% w of Aluminium and 0.072% of Zirconium measured via Ion Coupled Plasma.

Catalyst B

The procedure for the preparation of catalyst A has been repeated by using 38 mg metallocene C-1. The obtained supported catalytic system contains 8.0% w of Aluminium and 0.075% of Zirconium measured via Ion Coupled Plasma.

### Polymerization Examples 1-4

General Polymerization Process

The polymerizations were done in stainless steel fluidized bed reactors.

During the polymerization, the gas phase in each reactor was continuously analyzed by gaschromatography in order to determine the content of ethylene, propylene and hydrogen. Ethylene, propylene, 1-butene and hydrogen were fed in such a way that during the course of the polymerization their concentration in gas phase remained constant, using instruments that measure and/or regulate the flow of the monomers.

The operation was continuous in two stages, each one comprising the polymerization of the monomers in gas phase.

Propylene was prepolymerized in liquid propane in a 75 litres stainless steel loop reactor with an internal temperature of 35° C. in the presence of a catalyst system prepared as described above (amounts of catalyst feed are reported in table 1).

1st stage—The thus obtained prepolymer was discharged into the first gas phase reactor, having a temperature of 75° C. and a pressure of 24 bar. Triethylaluminum was fed as scavenger. Thereafter, hydrogen and propylene and an inert gas were fed in the ratio and quantities reported in Table 1, the residence times are reported in Table 1.

2nd stage—After removing a sample to carry out the various analyses, the polymer was purged to remove propylene and was discharged into the second phase reactor having a temperature of 65° C. and a pressure indicated in table 1. Thereafter, hydrogen, ethylene, 1-butene and an inert gas were fed in the ratio and quantities reported in Table 1, to obtain the composition of the gas phase reported in Table 1. Residence times are indicated in Table 1.

TABLE 1

| | Ex. 1 | Ex. 2 | Ex. 3* | Ex. 4^{#} |
|---|---|---|---|---|
| prepolymerization | cat A | cat A | cat A | cat B |
| catalyst fed (g/h) | 22.0 | 30 | 25 | 26.7 |
| propane fed (mol) | 27 | 27 | 27 | 27 |
| propane/propylene weight | 4.4 | 4.4 | 4.4 | 4.4 |
| ratio | | | | |
| residence time (min) | 16 | 16 | 16 | 16 |
| 1st stage (gas phase) | | | | |
| Split (% wt.) | 62 | 70 | 28 | 66 |
| trialkylaluminum fed (g/h) | 20.0 | 20.0 | 15 | 20 |
| H₂/propylene molar ratio | 0.0006 | 0.0008 | 0.0006 | 0.0008 |
| Propylene in gas phase | 19 | 19 | 30 | 20 |
| (% mol) | | | | |
| Bulk poured density g(/cc) | 0.429 | 0.420 | 0.460 | 0.421 |
| residence time (min) | 93 | 62 | 64.5 | 75 |
| Sol. Xyl. (% wt) | 0.23 | 0.30 | 0.50 | 0.26 |
| 2nd stage (gas phase) | | | | |
| Split (% wt) | 38 | 30 | 66.5 | 34 |
| H₂/ethylene molar ratio | 0.0137 | 0.0084 | 0.0130 | 0.0122 |
| 1-butene/(ethylene + | 0.023 | 0.029 | 0.023 | 0.064 |
| 1-butene) | | | | |
| residence time (min) | 170 | 69 | 174 | 175 |
| 1-butene in the copolymer | 9.5 | 11.8 | 12.9 | 10.2 |
| (wt %) | | | | |
| polymer analysis | | | | |
| production Kg/g | 5.0 | 3.5 | 5.0 | 4.0 |
| Ethylene tot. (% wt) | 34.2 | 26.2 | 58.8 | 31.2 |
| 1-butene tot (wt %) | 3.6 | 3.5 | 8.6 | 3.5 |
| haze 1 mm thick plaque % | 18.2 | 20.1 | 43.3 | 30.2 |
| (ASTM D 1003) | | | | |

*temperature in the second stage was 75° C.
^{#}comparative

By comparing examples 1 and 2 and comparative examples 4 it clearly results that by using the catalyst according to the present invention polymers having a lower value of haze are obtained.

1-20. (canceled)

21. A multistage process comprising the following steps:
polymerizing a propylene resin and optionally one or more monomers selected from ethylene or alpha olefins of formula CH₂═CHT¹, wherein T¹ is a C₂-C₂₀ alkyl radical in presence of a catalyst system, the catalyst system supported on an inert carrier, comprising:
i) at least one metallocene compound of formula (I): 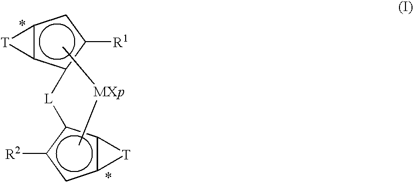
wherein M is a transition metal selected from those belonging to group 3, 4, 5, 6 or to a lanthanide or actinide group in the Periodic Table of the Elements;
p is an integer from 0 to 3, wherein p is equal to a formal oxidation state of M minus 2;
X, same or different, is hydrogen, a halogen, or R, OR, OSO₂CF₃, OCOR, SR, NR₂ or PR₂, wherein R is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical, optionally containing heteroatoms belonging to groups 13-17 of the Periodic Table of the Elements; or two X can optionally form a substituted or unsubstituted butadienyl radical or OR′O, wherein R′ is a divalent radical selected from C₁-C₂₀ alkylidene, C₆-C₄₀ arylidene, C₇-C₄₀ alkylarylidene and C₇-C₄₀ arylalkylidene radicals;
L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms;
R¹ and R², equal to or different from each other, are linear or branched, saturated or unsaturated C₁-C₂₀-alkyl radicals, optionally containing one or more heteroatoms belonging to groups 13-17 of the Periodic Table of the Elements;
T, equal to or different from each other, is a moiety of formula (IIa) or (IIb): 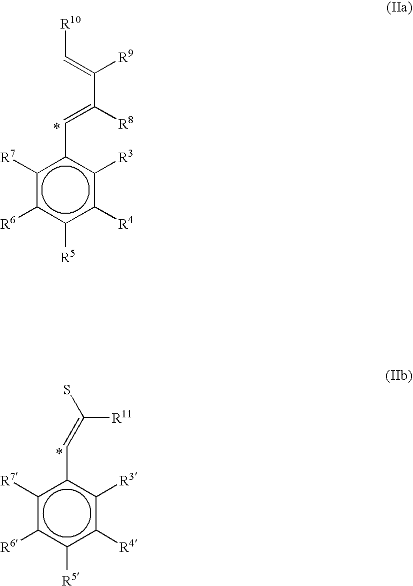
wherein the atom marked with symbol * bonds the atom marked with the same symbol in the metallocene compound of formula (I);
R³, R⁴, R⁵, R⁶ and R⁷, equal to or different from each other, are hydrogen or linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; or two or more R⁸, R⁴, R⁵, R⁶ and R⁷ can join to form a 4-7 membered saturated or unsaturated ring, said ring can bear at least one C₁-C₂₀ alkyl substituent;
with the proviso that at least one substituent selected from the group consisting of R³, R⁴, R⁵, R⁶ and R⁷ is of formula (III): 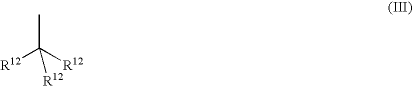
wherein R¹², equal to or different from each other, is a C₁-C₁₀ alkyl radical;
R⁸, R⁹ and R¹⁰, equal to or different from each other, are hydrogen or linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; or two or more R³, R⁹ and R¹⁰ can join to form a 4-7 membered saturated or unsaturated ring, said ring can bear at least one C₁-C₁₀ alkyl substituent;
R¹¹ is hydrogen or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements;
R^{3′}, R^{4′}, R^{5′}, R^{6′} and R^{7′} equal to or different from each other, are hydrogen or linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; or two or more R^{3′} R^{4′} R^{5′} R^{6′} and R^{7′} can join to form a 4-7 membered saturated or unsaturated ring, said ring can bear at least one C₁-C₂₀ alkyl substituent;
ii) an alumoxane or a compound capable of forming an alkyl metallocene cation;
contacting under polymerization conditions in a gas phase, ethylene with one or more alpha olefins of formula CH₂═CHT¹, wherein T¹ is a C₂-C₂₀ alkyl radical, and optionally with a non-conjugated diene, to produce an ethylene resin, the ethylene resin is produced in presence of the propylene resin, wherein the amount of the propylene resin ranges from 5% by weight to 90% by weight, and the amount of the ethylene resin ranges from 10% by weight to 95% by weight.

22. The process according to claim 21, wherein the catalyst system further comprises iii) an organo aluminum compound.

23. The process according to claim 22, wherein the process of polymerizing a propylene resin is carried out in presence of an additional organo aluminum compound.

24. The process according to claim 21, wherein M is titanium, zirconium or hafnium; p is 2; X is hydrogen, a halogen, or R, wherein R is defined in claim 1; L is selected from the group consisting of is Si(CH₃)₂, SiPh₂, SiPhMe, SiMe(SiMe₃), CH₂, (CH₂)₂, (CH₂)₃ and C(CH₃)₂; and R¹ and R² are methyl or ethyl radicals.

25. The process according to claim 21, wherein at least one substituent selected from the group consisting of R^{3′}, R^{4′}, R^{5′}, R^{6′} and R^{7′} is a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radical, optionally containing one or more heteroatoms belonging to groups 13-17 of the Periodic Table of the Elements.

26. The process according to claim 21, wherein R³, R⁴, R⁶, R⁷, R^{3′}, R^{4′}, R^{6′} and R^{7′} are hydrogen.

27. The process according to claim 21, wherein R¹¹ is a linear or branched, saturated C₁-C₂₀-alkyl.

28. The process according to claim 21, wherein T have formula (IIa) and R⁹ is a C₁-C₂₀ alkyl radical.

29. The process according to claim 21, wherein T have formula (IIb).

30. The process according to claim 21, wherein T have formula (IIa) and R⁹ is hydrogen.

31. The process according to claim 21, wherein T are different and have formulas (IIb) and (IIa).

32. The process according to claim 21, wherein T have formula (IIb) and R¹¹ is a linear or branched, saturated C₁-C₂₀-alkyl radical.

33. The process according to claim 21, wherein the catalyst system is supported on an organic polymeric support.

34. The process according to claim 21, wherein the process of polymerizing a propylene resin further comprises a prepolymerization step.

35. The process according to claim 21, wherein the process of polymerizing a propylene resin is carried out in presence of hydrogen.

36. The process according to claim 21, wherein the process of polymerizing an ethylene resin is carried out in presence of hydrogen.

37. The process according to claim 21, wherein the propylene resin produced comprises from 30% to 70% by weight of a propylene homopolymer or propylene copolymer containing up to 20% by mol of ethylene or one or more alpha olefins of formula CH₂═CHT¹.

38. The process according to claim 21 wherein the ethylene resin produced comprises from 30% to 70% by weight of an ethylene copolymer having from 4% by mol to 60% by mol of comonomers of formula CH₂═CHT¹ and optionally up to 20% by mol of a non conjugated diene.

39. The process according to claim 21, wherein the propylene resin is a propylene homopolymer.

40. The process according to claim 21, wherein the ethylene resin is an ethylene 1-butene copolymer.
